(19) United States
(12) Patent Application Publication
(10) Pub. No.: US 2022/0122620 A1
(43) Pub. Date: Apr. 21, 2022

(54) EMERGENCY SIREN DETECTION FOR AUTONOMOUS VEHICLES

(71) Applicant: Argo AI, LLC, Pittsburgh, PA (US)

(72) Inventors: Olivia Watkins, Upland, CA (US); Nathan Pendleton, San Jose, CA (US); Guy Hotson, Mountain View, CA (US); Chao Fang, Sunnyvale, CA (US); Richard L. Kwant, San Bruno, CA (US); Weihua Gao, Santa Clara, CA (US); Deva Ramanan, Pittsburgh, PA (US); Nicolas Cebron, Sunnyvale, CA (US); Brett Browning, Pittsburgh, PA (US)

(21) Appl. No.: 17/073,680

(22) Filed: Oct. 19, 2020

(51) Int. Cl. G10L 19/06; G06N 3/04; G05D 1/02

(52) U.S. Cl. CPC G10L 19/06; G05D 1/0255; G06N 3/04

(57) ABSTRACT

Systems and methods for siren detection in a vehicle are provided. A method includes recording an audio segment, using a first audio recording device coupled to an autonomous vehicle, separating, using a computing device coupled to the autonomous vehicle, the audio segment into one or more audio clips, generating a spectrogram of the one or more audio clips, and inputting each spectrogram into a Convolutional Neural Network (CNN) run on the computing device. The CNN may be pretrained to detect one or more sirens present in spectrographic data. The method further includes determining, using the CNN, whether a siren is present in the audio segment, and if the siren is determined to be present in the audio segment, determining a course of action of the autonomous vehicle.

### BACKGROUND

### Statement of the Technical Field

The present disclosure relates to audio frequency analysis and, in particular, to audio analysis for the detection of one or more sirens by autonomous vehicles.

### Description of the Related Art

With the continuous development of artificial intelligence in various fields, including autonomous transportation systems, autonomous vehicles (AVs) are becoming more prevalent and common on the roads. However, AVs present a number of issues which must be addressed in order to avoid collisions and maintain a safe passenger experience. These issues include determining an appropriate speed at which the AV should be traveling at any given time, image and spatial analysis for determining the location and position of the road, any markings or signage, and any other objects which may come into the path of the AV (for example, other vehicles, pedestrians, animals, etc.). Further, the AV must also determine whether or not the “additional roadway actors” (e.g. vehicles, cyclists, pedestrians, and/or other road users) are in fact stationary or in motion.

A further input which must be addressed in order to maintain safety on the roads is audio information analysis. Many objects may be approaching an AV or an AV's path, but may not be within the AV's sensing “line of sight” Field of View (FoV). This poses a concern for both AVs and traditional human driven vehicles. Some vehicles, such as emergency vehicles, may deploy sirens, which are effective methods to alert many road users to the presence of such a vehicle, even when that vehicle is not within a traditional “line of sight.” These sirens enable drivers to identify an emergency vehicle and infer a general location of the emergency vehicle and a general direction in which the emergency vehicle is traveling. These sirens are typically played with distinct frequencies and speeds in order for drivers to easily and quickly identify that they are the sirens of emergency vehicles. In order for AVs to safely traverse the roadways, the AVs must also be able to accurately detect, isolate, and analyze audio feeds to determine whether there is a siren and a general position of the siren.

For at least these reasons, a system and method for siren detection for implementation in AVs is needed.

### SUMMARY

According to an aspect of the present disclosure, a method for siren detection in a vehicle is provided. The method includes: recording an audio segment; using a first audio recording device coupled to an autonomous vehicle; separating, using a computing device coupled to the autonomous vehicle, the audio segment into one or more audio clips; generating a spectrogram of the one or more audio clips; and inputting each spectrogram into a Convolutional Neural Network (CNN) run on the computing device. The CNN may be pretrained to detect one or more sirens present in spectrographic data. The method further includes determining, using the CNN, whether a siren is present in the audio segment and, if the siren is determined to be present in the audio segment, determining a course of action of the autonomous vehicle.

According to various embodiments, the generating the spectrogram includes performing a transformation on each of the audio clips to a lower dimensional feature representation.

According to various embodiments, the transformation includes at least one of the following: Fast Fourier Transformation; Mel Frequency Cepstral Coefficients; or Constant-Q Transform.

According to various embodiments, the method further includes, if the siren is determined to be present in the audio segment, localizing, using the computing device, a source of the siren in relation to the autonomous vehicle.

According to various embodiments, the method further includes, if the siren is determined to be present in the audio segment, determining a motion of the siren.

According to various embodiments, the method further includes, if the siren is determined to be present in the audio segment, calculating, using the computing device, a trajectory of the siren.

According to various embodiments, the course of action includes at least one of the following: change direction; alter speed; stop; pull off the road; and park.

According to another aspect of the present disclosure, a method for siren detection in a vehicle is provided. The method includes: recording a first audio segment, using a first audio recording device coupled to an autonomous vehicle; recording a second audio segment, using a second audio recording device coupled to the autonomous vehicle; separating, using a computing device coupled to the autonomous vehicle, the first audio segment and the second audio segment each into one or more audio clips; generating a spectrogram of each of the one or more audio clips; and inputting each spectrogram into a CNN run on the computing device. The CNN may be pretrained to detect one or more sirens present in spectrographic data. The method further includes determining, using the CNN, whether a siren is present in each of the first audio segment and the second audio segment.

According to various embodiments, the generating the spectrogram includes performing a transformation on each of the audio clips to a lower dimensional feature representation.

According to various embodiments, the transformation includes at least one of the following: Fast Fourier Transformation; Mel Frequency Cepstral Coefficients; or Constant-Q Transform.

According to various embodiments, the method further includes, if the siren is determined to be present in the first audio segment and the second audio segment, localizing, using the computing device, a source of the siren in relation to the autonomous vehicle.

According to various embodiments, the method further includes, if the siren is determined to be present in the first audio segment and the second audio segment, determining a motion of the siren.

According to various embodiments, the method further includes, if the siren is determined to be present in the first audio segment and the second audio segment, calculating, using the computing device, a trajectory of the siren.

According to various embodiments, the method further includes, if the siren is determined to be present in the first audio segment and the second audio segment, determining a course of action of the autonomous vehicle.

According to various embodiments, the course of action includes at least one of the following: change direction; alter speed; stop; pull off the road; and park.

According to yet another aspect of the present disclosure, a system for siren detection in a vehicle is provided. The system includes an autonomous vehicle and one or more audio recording devices coupled to the autonomous vehicle, each of the one or more audio recording devices being configured to record an audio segment. The system further includes a computing device coupled to the autonomous vehicle. The computing device includes a processor and a memory. The computing device is configured to run a CNN and includes instructions, wherein the instructions cause the computing device to: separate one or more audio segments into one or more audio clips; generate a spectrogram of the one or more audio clips; input each spectrogram into the CNN; and determine, using the CNN, whether a siren is present in the audio segment. The CNN may be pretrained to detect one or more sirens present in spectrographic data.

According to various embodiments, the instructions are further configured to cause the computing device to, if the siren is determined to be present in the audio segment, localize a source of the siren in relation to the autonomous vehicle.

According to various embodiments, the instructions are further configured to cause the computing device to, if the siren is determined to be present in the audio segment, determine a motion of the siren.

According to various embodiments, the instructions are further configured to cause the computing device to, if the siren is determined to be present in the audio segment, calculate, using the computing device, a trajectory of the siren.

### BRIEF DESCRIPTION OF THE DRAWINGS

FIG. 1 is an example of a system for detecting and analyzing one or more emergency sirens, in accordance with various embodiments of the present disclosure.

FIG. 2 is an example of a graphical representation of a wail-type emergency siren, in accordance with the present disclosure.

FIG. 3 is an example of a graphical representation of a yelp-type emergency siren, in accordance with the present disclosure.

FIG. 4 is a block/flow diagram for training a Convolutional Neural Network (CNN) to recognize one or more emergency sirens, in accordance with the present disclosure.

FIG. 5 is a flowchart of a method for recognizing one or more emergency sirens using a pretrained CNN, in accordance with the present disclosure.

FIG. 6 is a spectrogram of an audio clip of an emergency siren, in accordance with the present disclosure.

FIG. 7 is a spectrogram of an audio clip of an emergency siren, in accordance with the present disclosure.

FIG. 8 is an illustration of an illustrative computing device, in accordance with the present disclosure.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” Definitions for additional terms that are relevant to this document are included at the end of this Detailed Description.

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

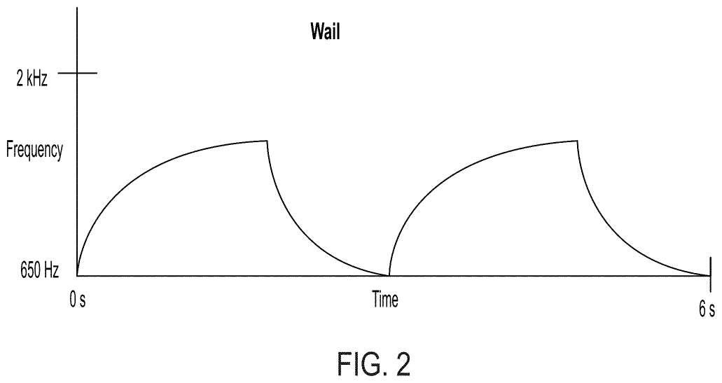

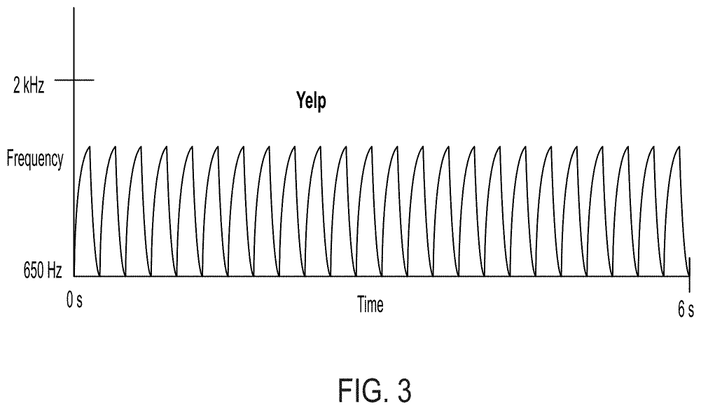

There are various types of sirens used by emergency vehicles and emergency personnel. For example, in the United States, emergency sirens typically provide either a “wail” or a “yelp” type of sound. Wails are typically produced by legacy sirens, which may be mechanical or electro-mechanical, and modern electronic sirens, and have typical periods of approximately 0.167-0.500 Hz, although other periods may be used. Yelps are typically produced by modern electronic sirens and have typical periods of 2.5-4.2 Hz. An example graphical representation of a wail-type emergency siren is illustratively depicted in FIG. 2, while an example graphical representation of a yelp-type emergency siren is illustratively depicted in FIG. 3.

For both wail-type sirens and yelp-type sirens, maximum sound pressure levels for the sirens are approximately in the 1,000 Hz range or 2,000 Hz range. It is noted, however, that other types of sirens, or sirens not in these maximum sound pressure ranges, may also be used. It is also noted that not all emergency sirens have the same standard cycle rates, minimum and maximum fundamental frequencies, and octave band in which maximum sound pressure is measured. For example, the frequency and cycle rate requirements for wails and yelps may differ in accordance with governmental regulations, standardized practices, and the like. For example, the California Code of Regulations Title 13 (“CCR Title 13”), SAE International®'s standards on emergency vehicle sirens (“SAE J1849”), and the General Services Administration (GSA)'s Federal Specification for Star-of-Life Ambulances (“GSA K-Specification”) each include regulations on the frequency and cycle rates of emergency sirens, which are presented below in Table 1 and Table 2.

TABLE 1
Frequency and Cycle Rate Requirements for Wail

| | | | GSA K- |
|---|---|---|---|
| Parameter | CCR Title 13 | SAE J1849 | Specification |
| Cycle rate lower limit in cycles | 10 | 10 | 10 |
| per minute (cpm) | | | |
| Cycle rate upper limit (cpm) | 30 | 30 | 18 |
| Minimum range of fundamental | None | 850 Hz | One Octave* |
| frequency | | | |
| Minimum fundamental | 100 | 650 | 500 |
| frequency (Hz) | | | |
| Maximum fundamental | 2500 | 2000 | 2000 |
| frequency (Hz) | | | |
| Octave band in which maximum | 1000 or 2000 | None | 1000 or 2000 |
| sound pressure level is | | | |
| measured (Hz) | | | |

*Maximum fundamental frequency is equal to twice the minimum fundamental frequency.

TABLE 2
Frequency and Cycle Rate Requirements for Yelp

| | | | GSA K- |
|---|---|---|---|
| Parameter | CCR Title 13 | SAE J1849 | Specification |
| Cycle rate lower limit in cycles | 150 | 150 | 150 |
| per minute (cpm) | | | |
| Cycle rate upper limit (cpm) | 250 | 250 | 250 |
| Minimum range of fundamental | None | 850 Hz | One Octave* |
| frequency | | | |
| Minimum fundamental | 100 | 650 | 500 |
| frequency (Hz) | | | |
| Maximum fundamental | 2500 | 2000 | 2000 |
| frequency (Hz) | | | |
| Octave band in which maximum | 1000 or 2000 | None | 1000 or 2000 |
| sound pressure level is | | | |
| measured (Hz) | | | |

*Maximum fundamental frequency is equal to twice the minimum fundamental frequency.

Emergency sirens, particularly those used on emergency vehicles (for example, fire engines, ambulances, police vehicles, etc.), typically provide instructions to motorists on how to properly, safely, and/or legally respond to an emergency vehicle producing a siren. This may include, for example, moving to the side of the road to allow for the emergency vehicle to pass, giving way for the emergency vehicle, stopping to allow for the emergency vehicle to pass, slowing vehicle speed (or coming to a stop) in the presence of an emergency vehicle, and/or any other appropriate and/or mandatory actions required in the presence of an emergency vehicle. Many of these actions may be determinant upon multiple factors, such as, for example, the location of the emergency vehicle and/or the vehicle listening to the siren, the speed of any vehicles involved, and/or whether it is safe or possible to slow down, stop, and/or move over in the presence of the emergency vehicle.

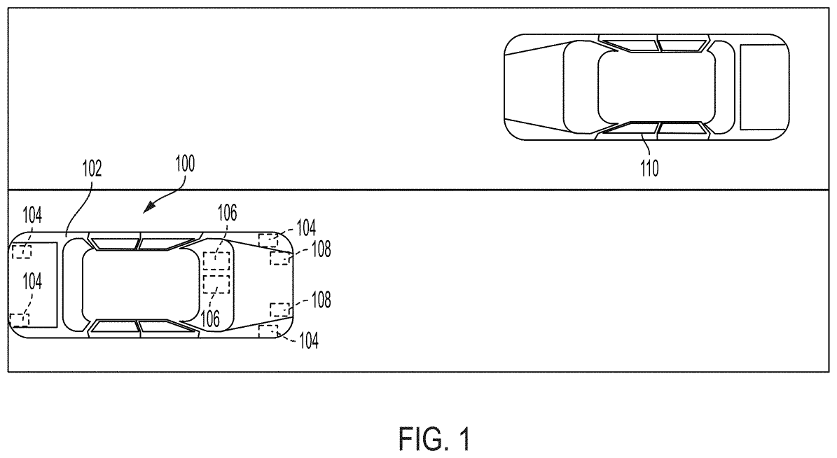

Referring now to FIG. 1, an example of an emergency siren detection system 100 is provided.

According to various embodiments, the system 100 includes an autonomous vehicle 102, which includes one or more audio recording devices 104 (for example, one or more microphones, etc.). The plurality of audio recording devices 104 results in the same audio event being recorded from multiple locations, enabling object position detection via acoustic location techniques such as, for example, the analysis of any time dilation and/or particle velocity between the audio recordings picked up by each of the plurality of audio recording devices 104.

The system 100 may include one or more computing devices 106. The one or more computing devices 106 may be coupled and/or integrated with the AV 102 and/or remote from the AV 102, with data collected by the plurality of audio recording devices being sent, via wired and/or wireless connection, to the one or more computing devices 106.

According to various embodiments, the one or more computing devices 106 are configured to perform a localization analysis on the audio dada (for example, using audio data captured from a first and a second audio recording device 106) using the CNN in order to localize the vehicle generating the detected emergency siren. According to various embodiments, once the data is fed into the CNN, the CNN localizes an approximate direction of an emergency vehicle 110 producing a siren and determines whether or not the emergency vehicle 110 is approaching.

According to various embodiments, the AV 102 may be equipped with any suitable number of audio recording devices 104 at various suitable positions. For example, according to an embodiment, AVs 102 may be equipped with three audio recording devices 104 in an overhead area of the AV 102.

According to various embodiments, the system 100 may include one or more image capturing devices 108 (for example, cameras, video recorders, etc.). The one or more image capturing devices may visually identify the emergency vehicle and may associate the detected and analyzed siren with the visually identified emergency vehicle in order to more accurately track the emergency vehicle.

According to various embodiments, each audio recording device 104 in the plurality of audio recording devices 104 records audio data collected from the surroundings of the AV 102. The system 100, after recording the audio data, analyzes the audio data, using a pretrained Convolutional Neural Network (CNN) to extrapolate whether an emergency siren has been detected and any other useful metrics pertaining to the emergency siren (for example, the location of the origin of the emergency siren in relation to the AV 102, the speed at which the vehicle generating the emergency siren is moving, a projected path of the emergency vehicle, and/or any other useful metrics pertaining to the emergency siren). It is noted, however, that other forms of neural network such as, for example, a Recurrent Neural Network (RNN), may alternatively or additionally be used in accordance with the spirit and principles of the present disclosure.

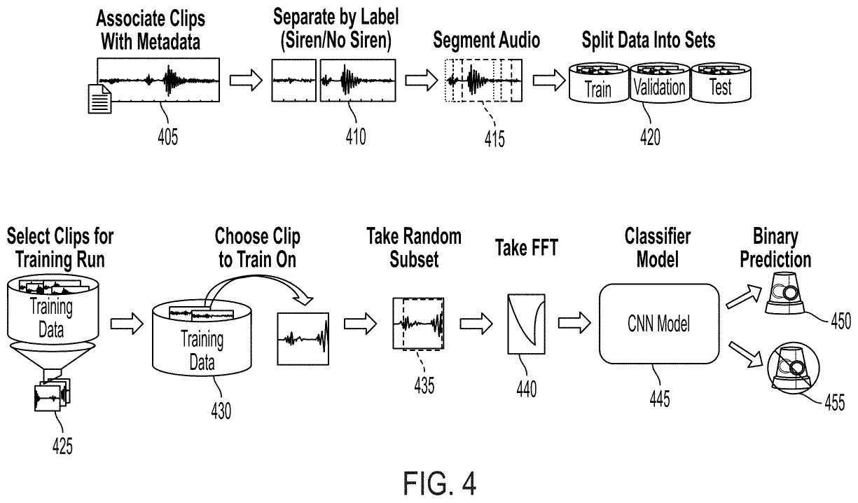

Referring now to FIG. 4, a block/flow diagram for training the CNN to recognize one or more emergency sirens is illustratively depicted.

According to various embodiments, the CNN is pretrained using known emergency sirens. With the variety of available and as-yet-undetermined types of emergency sirens, the CNN enables the system to be efficient and capable of being retrained to detect the various types of emergency sirens.

According to various embodiments, audio recordings are made of various known types of emergency sirens. These audio recording are separated into separate audio clips. These clips, at 405, are associated with appropriate metadata such as, for example, the type of emergency siren present in the audio clip. For example, the audio clip may be for a known wail-type emergency siren or yelp-type emergency siren. The audio clip, at 410, is then separated into labelled sections, each labelled section representing the presence of an emergency siren (Siren), or the absence of an emergency siren (No Siren). The audio clip, at 415, is then segmented into a segment containing a recording of the emergency siren. The segmented audio clip, at 420, is then designated into one of three data sets: a training data set, a validation data set, or a test data set.

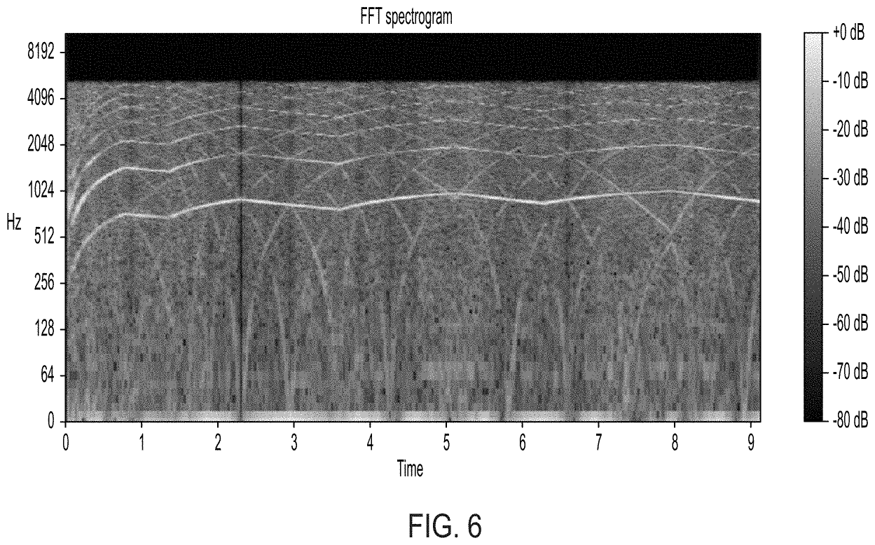

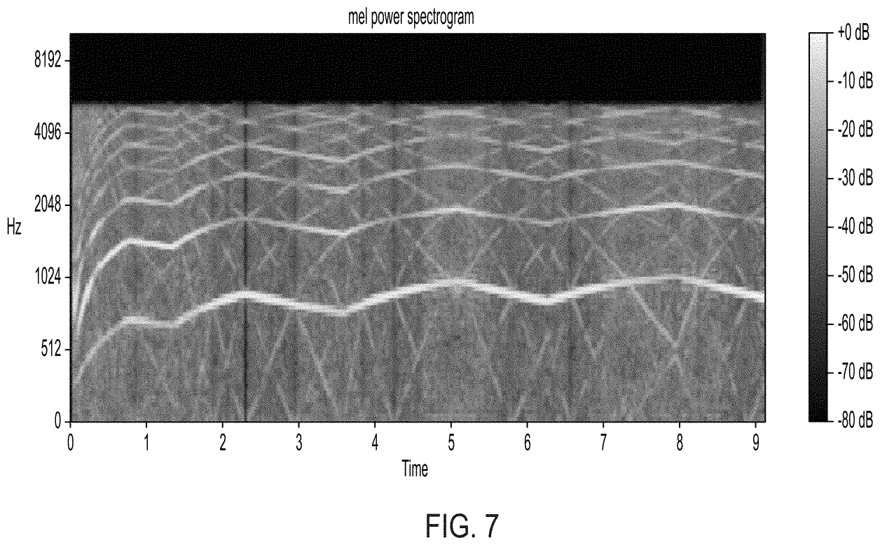

At 425, the training data set is accessed and, at 430, an audio segment clip from the training data set is chosen for training the CNN. At 435, a random subset of the chosen audio segment clip from the training data set is then taken and, at 440, a transformation of the random subset to a lower dimensional feature representation (for example, using coarser frequency binning) is performed and a spectrogram of the random subset is generated. The spectrograms graphically and visual represent the magnitude of various frequencies of the audio clips over time. According to some embodiments, Fast Fourier Transformation (FFT) techniques are used in the conversion of the audio clips into spectrograms (an example of which is illustrated in FIG. 6). It is noted, however, that other suitable transform techniques (for example, Mel Frequency Cepstral Coefficients (MFCCs) (an example of which is shown in FIG. 7), Constant-Q Transform, etc.) for generating the spectrograms may be used, while maintaining the spirit of the present disclosure.

The data inherent in the spectrogram is then, at 445, incorporated into the CNN classifier model. According to various embodiments, the CNN model is programmed to generate a binary prediction, determining, at 450, that there is a siren or, at 455, that there is no siren. While the example shown in FIG. 4 demonstrates a binary prediction model, it is noted that, according to various embodiments of the present disclosure, prediction models having three or more prediction classifications may be incorporated.

According to various embodiments, the audio clips of the validation set are used upon the pretrained CNN to evaluate and validate the model formed by the CNN by the incorporation of the audio clips of the training data set. Once the CNN is trained, the audio clips of the test data set are used to test the pretrained model of the CNN.

Once the CNN is pretrained for detecting one or more emergency signals, the CNN can be incorporated in the computing device or devices 106 of the AV 102.

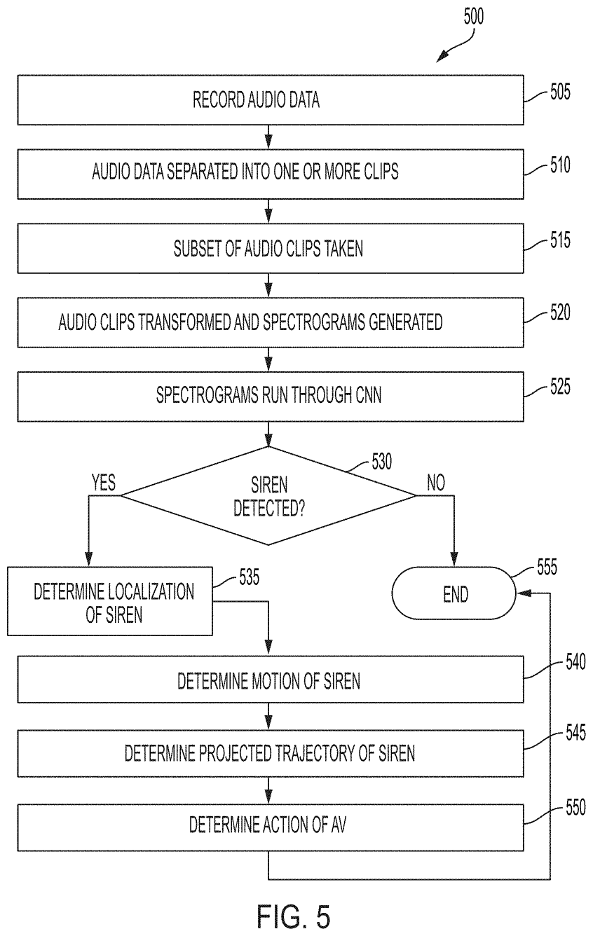

Referring now to FIG. 5, a flowchart of a method 500 for recognizing one or more emergency sirens using the pretrained CNN is illustratively depicted.

According to various embodiments, at 505, audio data is recorded using a plurality of audio recording devices 104 (for example, a first audio segment of a first audio recording device, a second audio segment of a second audio recording device, etc.). The one or more computing devices 106, at 510, separates the audio data recorded for each of the plurality of audio recording devices 104 into one or more audio clips, wherein each of the plurality of audio clips correlates to the same record time, and the audio clips may include an emergency siren.

At 515, a random subset of each of the audio clips is taken and, at 520, a transformation of the random subset to a lower dimensional feature representation (for example, using coarser frequency binning) is performed and a spectrogram of the random subset is generated. The transformation and generation of the spectrograms allows for the removal of many unwanted and/or irrelevant frequencies, producing a more accurate sample. At 525, each of the spectrograms is run through the CNN and analyzed to determine, at 530, whether a siren is detected.

If no siren is detected, then method ends, at 555.

If a siren is detected, localization is performed, at 535, to determine the location of the emergency siren in relation to the AV 102. Once localization is determined, motion of the siren is detected, at 540. Using the localization and motion metrics, a projected trajectory of the siren is calculated, at 545. According to various embodiments, localization may be performed using one or more means of localization such as, for example, multilateration, trilateration, triangulation, position estimation using an angle of arrival, and/or other suitable means. The localization means may incorporate data collected using one or more sensors coupled to the AV 102, such as, for example, the one or more audio recording devices 104.

According to various embodiments, the localization may, additionally or alternatively, incorporate associating one or more images of a vehicle or object emitting the siren with one or more audio recordings of the siren. This may enhance tracking of the vehicle or object emitting the siren. In various embodiments, the one or more audio recording devices 104 records one or more audio recordings of the siren, and the one or more image capturing devices 108 (for example, cameras, video recorders, etc.) capture one or more images which include the vehicle or object emitting the siren. Using localization techniques such as those described above, the location of the vehicle or object emitting the siren can be determined and, using this localization, the position of the vehicle or object within the one or more images can be determined based on position data associated with the one or more images. Once both the siren (within the one or more audio recordings) and the vehicle or object (within the one or more images) are isolated, the system may associate the one or more audio recordings of the siren with the one or more images of the vehicle or object emitting the siren.

By understanding the trajectory of the emergency siren, an appropriate action by the AV 102 can be determined, at 550. The appropriate action may be to issue a command to cause the vehicle to slow down by applying a braking system and/or by decelerating, to change direction using a steering controller, to pull off the road, to stop, to pull into a parking location, to yield to an emergency vehicle, and/or any other suitable action which may be taken by the AV 102. For example, map data may be used to determine areas of minimal risk to which the AV 102 may travel in the event that movement to one or more of these areas of minimal risk is determined to be appropriate (for example, if it is appropriate for the AV 102 to move to an area of minimal risk in order to enable an emergency vehicle to pass by the AV 102).

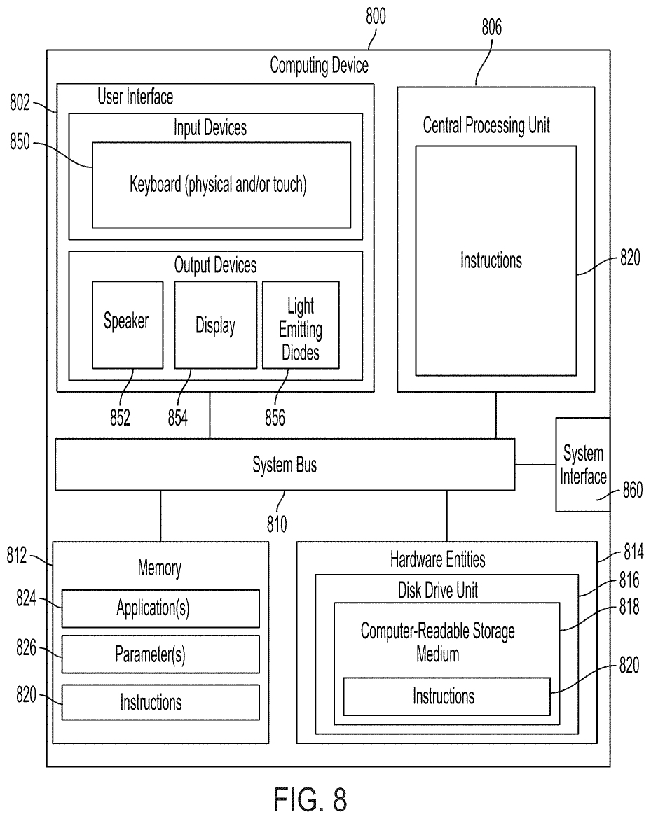

Referring now to FIG. 8, an illustration of an illustrative architecture for a computing device 800 is provided. The computing device 106 of FIG. 1 is the same as or similar to computing device 800. As such, the discussion of computing device 800 is sufficient for understanding the computing device 106 of FIG. 1.

Computing device 800 may include more or less components than those shown in FIG. 8. However, the components shown are sufficient to disclose an illustrative solution implementing the present solution. The hardware architecture of FIG. 8 represents one implementation of a representative computing device configured to determine and localize one or more emergency sirens, as described herein. As such, the computing device 800 of FIG. 8 implements at least a portion of the method(s) described herein.

Some or all components of the computing device 800 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 8, the computing device 800 comprises a user interface 802, a Central Processing Unit (“CPU”) 806, a system bus 810, a memory 812 connected to and accessible by other portions of computing device 800 through system bus 810, a system interface 860, and hardware entities 814 connected to system bus 810. The user interface can include input devices and output devices, which facilitate user-software interactions for controlling operations of the computing device 800. The input devices include, but are not limited to, a physical and/or touch keyboard 850. The input devices can be connected to the computing device 800 via a wired or wireless connection (e.g., a Bluetooth® connection). The output devices include, but are not limited to, a speaker 852, a display 854, and/or light emitting diodes 856. System interface 860 is configured to facilitate wired or wireless communications to and from external devices (e.g., network nodes such as access points, etc.).

At least some of the hardware entities 814 perform actions involving access to and use of memory 812, which can be a random access memory (“RAM”), a disk drive, flash memory, a compact disc read only memory (“CD-ROM”) and/or another hardware device that is capable of storing instructions and data. Hardware entities 814 can include a disk drive unit 816 comprising a computer-readable storage medium 418 on which is stored one or more sets of instructions 820 (e.g., software code) configured to implement one or more of the methodologies, procedures, or functions described herein. The instructions 820 can also reside, completely or at least partially, within the memory 812 and/or within the CPU 806 during execution thereof by the computing device 800. The memory 812 and the CPU 806 also can constitute machine-readable media. The term “machine-readable media”, as used here, refers to a single medium or multiple media (e.g., a centralized or distributed database, and/or associated caches and servers) that store the one or more sets of instructions 820. The term “machine-readable media”, as used here, also refers to any medium that is capable of storing, encoding or carrying a set of instructions 820 for execution by the computing device 800 and that cause the computing device 800 to perform any one or more of the methodologies of the present disclosure.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

1. A method for siren detection in a vehicle, comprising:
recording an audio segment, using a first audio recording device coupled to an autonomous vehicle;
separating, using a computing device coupled to the autonomous vehicle, the audio segment into one or more audio clips;
generating a spectrogram of each of the one or more audio clips;
inputting each spectrogram into a Convolutional Neural Network (CNN) run on the computing device,
wherein the CNN is pretrained to detect one or more sirens present in spectrographic data;
determining, using the CNN, whether a siren is present in the audio segment; and
in response to the siren being present in the audio segment, determining a course of action of the autonomous vehicle.

2. The method of claim 1, wherein the generating the spectrogram of each of the one or more audio clips includes:
performing a transformation on each of the one or more audio clips to a lower dimensional feature representation.

3. The method of claim 2, wherein the transformation includes at least one of the following:
Fast Fourier Transformation;
Mel Frequency Cepstral Coefficients; or
Constant-Q Transform.

4. The method of claim 1, further comprising:
if the siren is determined to be present in the audio segment, localizing, using the computing device, a source of the siren in relation to the autonomous vehicle.

5. The method of claim 4, further comprising:
if the siren is determined to be present in the audio segment, determining a motion of the siren.

6. The method of claim 5, further comprising:
if the siren is determined to be present in the audio segment, calculating, using the computing device, a trajectory of the siren.

7. The method of claim 1, wherein the course of action includes at least one of the following:
change direction;
alter speed;
stop;
pull off the road; or
park.

8. A method for siren detection in a vehicle, comprising:
recording a first audio segment, using a first audio recording device coupled to a vehicle;
recording a second audio segment, using a second audio recording device coupled to the vehicle;
separating, using a computing device coupled to the vehicle, the first audio segment and the second audio segment each into one or more audio clips;
generating a spectrogram of each of the one or more audio clips;
inputting each spectrogram into a Convolutional Neural Network (CNN) run on the computing device,
wherein the CNN is pretrained to detect one or more sirens present in spectrographic data; and
determining, using the CNN, whether a siren is present in each of the first audio segment and the second audio segment.

9. The method of claim 8, wherein the generating the spectrogram includes:
performing a transformation on each of the audio clips to a lower dimensional feature representation.

10. The method of claim 9, wherein the transformation includes at least one of the following:
Fast Fourier Transformation;
Mel Frequency Cepstral Coefficients; or
Constant-Q Transform.

11. The method of claim 8, further comprising:
if the siren is determined to be present in the first audio segment and the second audio segment, localizing, using the computing device, a source of the siren in relation to the autonomous vehicle.

12. The method of claim 11, further comprising:
if the siren is determined to be present in the first audio segment and the second audio segment, determining a motion of the siren.

13. The method of claim 12, further comprising:
if the siren is determined to be present in the first audio segment and the second audio segment, calculating, using the computing device, a trajectory of the siren.

14. The method of claim 13, further comprising:
if the siren is determined to be present in the first audio segment and the second audio segment, determining a course of action of the vehicle.

15. The method of claim 14, wherein the course of action includes at least one of the following:
change direction;
alter speed;
stop;
pull off the road; or
park.

16. A system for siren detection in a vehicle, comprising:
a vehicle;
one or more audio recording devices coupled to the vehicle, each of the one or more audio recording devices being configured to record an audio segment;
a computing device including:
a processor; and
a memory,
wherein the computing device is configured to run a Convolutional Neural Network (CNN) and includes instructions configured to cause the computing device to:
separate one or more audio segments into one or more audio clips;
generate a spectrogram of the one or more audio clips;
input each spectrogram into the CNN,
wherein the CNN is pretrained to detect one or more sirens present in spectrographic data; and
determine, using the CNN, whether a siren is present in the audio segment.

17. The system of claim 16, wherein the instructions are further configured to cause the computing device to:
if the siren is determined to be present in the audio segment, localize a source of the siren in relation to the vehicle.

18. The system of claim 17, wherein the instructions are further configured to cause the computing device to:
if the siren is determined to be present in the audio segment, determine a motion of the siren.

19. The system of claim 18, wherein the instructions are further configured to cause the computing device to:
if the siren is determined to be present in the audio segment, calculate, using the computing device, a trajectory of the siren.
